(19) United States
(12) Patent Application Publication
(10) Pub. No.: US 2020/0328931 A1
(43) Pub. Date: Oct. 15, 2020

(54) COMMUNICATION MANAGEMENT SYSTEM FOR SECURED FACILITY

(71) Applicant: TKH, Inc., Falkville, AL (US)

(72) Inventor: Karen Doss-Harbison, Falkville, AL (US)

(21) Appl. No.: 16/830,670

(22) Filed: Mar. 26, 2020

Related U.S. Application Data
(60) Provisional application No. 62/833,249, filed on Apr. 12, 2019.

(51) Int. Cl. H04L 12/24; H04L 29/06; H04L 29/08; H04M 7/00; H04W 88/06

(52) U.S. Cl. CPC H04L 41/022; H04L 41/046; H04W 88/06; H04L 67/10; H04M 7/006; H04L 63/20

(57) ABSTRACT

Methods for managing data communications with a secured facility are disclosed herein. In various aspects, the methods include the step of communicating data between a communication device located within the secured facility and an object located external of the secured facility via a communication pathway. The methods include the step of controlling the communicating of the data between the communication device and the object by a vendor included in the communication pathway, and the step of collecting at least portions of data communicated between the communication device, the vendor, and the object by an auditor into an auditor CDR independent of the vendor, the auditor being in communication with the communication pathway. Related apparatus and compositions of matter are also disclosed herein.

### CROSS-REFERENCE TO RELATED APPLICATIONS

The present application claims priority to and benefit of U.S. Provisional Patent Application No. 62/833,249 filed Apr. 12, 2019, which is hereby incorporated by reference in its entirety herein.

### FIELD OF THE INVENTION

The present disclosure relates to communication systems, and, more particularly, to communication systems and related methods of communicating from secured facilities.

### BACKGROUND OF THE INVENTION

Users of communication services within a secured facility may be held captive to a single vendor for communication services such as telephone communication. The users may be subject to fee gouging, inferior service, and other abuses by the vendor because the vendor is neither subject to consumer protection requirements nor subject to the forces of a competitive marketplace. The secured facility may be, for example, a detention facility such as a jail, brig, stockade, prison, immigration detention facility, psychiatric hospital, or addiction treatment facility. Users may be, for example, inmates within the detention facility. Inmates may include, for example, persons held in the detention facility while either awaiting trial, awaiting deportation, or serving a sentence. Inmates may include, for example, persons detained in the psychiatric hospital or addiction treatment facility. As additional examples, the secured facility may be a military installation, secured government facility, or secured commercial facility such as a corporate research center or defense plant. Users may include personnel within the military installation, secured government facility, or secured commercial facility. Such personnel may include, for example, persons holding a government security clearance or private sector equivalent, and the government security clearance or private sector equivalent may be required for access to the secured government facility or secured commercial facility.

The U.S. Federal Communication Commission (FCC) currently regulates certain interstate prison telephone calls. In March of 2018, a bipartisan group of U.S. senators introduced a Senate bill, the “Inmate Calling Technical Corrections Act of 2018”, that restores federal authority to crack down on what prison reform advocates term the usurious, abusive, and exploitative business practices engaged in by various companies that service the U.S. prison telephone industry. Secured facilities may be required to monitor charges by vendors in order to comply with FCC regulations and any provisions of the “Inmate Calling Technical Corrections Act of 2018” or other such reform legislation that passes into law. The FCC does not have authority to regulate certain intrastate prison telephone communications, which may be regulated by state authorities.

The types of communication services offered to users are being increased. Accordingly, communication services include not only analog telephone communications (PSTN/POTs) but also network cloud based digital communications such as voice over Internet protocol (VOIP) communications, video communications, email, and web-based communications including banking transactions such as deposits to and payments from a bank account. Such network cloud based digital communications may evade federal regulation, state regulation, various facility rules governing communications from the secured facility, court orders governing communications from a particular user, and otherwise evade auditing or control. Such evasions may have a direct negative impact on local, state and federal communication taxes. For example, network cloud based digital communications may make it nearly impossible to reconcile tax revenue, confirm the occurrence of required communication events, or confirm the occurrence of prioritized communication events.

Some vendors prevent access to communication event metadata records of communication events that may be needed in order for the secured facility to conduct the auditing required for compliance with, for example, statues, regulations, and court orders. A communication event metadata record (CDR) is created as a product of a communication event such as a discrete set of analog or digital communications by a particular user. CDR's may include, for example, the time of the communication event, type of communication event (such as email, video, telephone), and recipient of the communication event. CDR's, as used herein, may include records of the content of the communication event such as audio recording or text including other data communicated during the communication event. Without access to CDR's, it is impossible for anyone, other than the single-source vendor, to audit vendor deductions from the user's bank account for communication services or to analyze elements of the user's communication events such as time talked, telephone number called, time video visited, classes taken, coursework submitted, taxes paid, etc.

Furthermore, without access to CDR's, it is impossible to authenticate that rules governing users' communication events are actually being enforced by the vendor. These rules, for example, may be promulgated by the secured facility, law enforcement, or court order, and are not to be ignored. Such rules may include, for example, limitations on time-of-day of communication event, duration of communication event, allowed recipients of communication event, blocked recipients of communication event, cost of communication event, non-recording of certain confidential communication events such as attorney-client communications, and type of communication event. Vendors charge different taxes, rates, and fees at the end of each communication event. Regulated communication events are governed by different tax rules than non-regulated communication events, and it is impossible to determine vendor compliance with the tax rules without access to the CDR's. Furthermore, communication events conducted by indigent users are paid for by government funds, and it is impossible to audit these expenditures of government funds without access to the CDR's.

Accordingly, there is a need for improved communication management systems for secured facilities, as well as related methods, and compositions of matter.

### BRIEF SUMMARY OF THE INVENTION

These and other needs and disadvantages may be overcome by the communication management systems, related methods, and related compositions of matter disclosed herein. Additional improvements and advantages may be recognized by those of ordinary skill in the art upon study of the present disclosure.

Methods for managing data communication with a secured facility are disclosed herein. In various aspects, the methods include the step of communicating data between a communication device located within the secured facility and an object located external of the secured facility via a communication pathway. The methods include the step of controlling the communicating of the data between the communication device and the object by a vendor included in the communication pathway, and the step of collecting at least portions of data communicated between the communication device, the vendor, and the object by an auditor into an auditor CDR independent of the vendor, the auditor being in communication with the communication pathway. The methods may include the step of determining that the communication of data between the communication device and the object complies with auditor rules. The auditor rules may be specific to a user of the communication device, and the auditor rules may be specific to the object. Payment received by the vendor for communication of the data may be included in the auditor CDR and may be tested for compliance with rules included in the auditor rules.

Related communication management systems for data communication with a user located within a secured facility are also disclosed herein. Compositions of matter that include non-transitory computer readable media storing a computer program comprising instructions that, when executed, cause a computer to perform the steps of the methods for managing data communications with a secured facility are also disclosed herein.

This summary is presented to provide a basic understanding of some aspects of the methods, related apparatus, and related compositions of matter disclosed herein as a prelude to the detailed description that follows below. Accordingly, this summary is not intended to identify key elements of the methods, apparatus, and compositions of matter disclosed herein or to delineate the scope thereof.

### BRIEF DESCRIPTION OF THE DRAWINGS

FIG. 1 illustrates by schematic diagram an exemplary implementation of a communication management system;

FIG. 2 illustrates by schematic diagram a second exemplary implementation of a communication management system;

FIG. 3 illustrates by schematic diagram a third exemplary implementation of a communication management system;

FIG. 4 illustrates by process flow chart an exemplary method of implementing a communication event using the exemplary communication management system of FIG. 1, FIG. 2, and FIG. 3;

FIG. 5 illustrates by process flow chart a second exemplary method of implementing a communication event using the exemplary communication management system of FIG. 1, FIG. 2, and FIG. 3;

FIG. 6 illustrates by process flow chart an exemplary method of implementing a communication event using the exemplary communication management system of FIG. 3; and,

FIG. 7 illustrates by process flow chart a third exemplary method of implementing a communication event using the exemplary communication management system of FIG. 1, FIG. 2, and FIG. 3.

The Figures are exemplary only, and the implementations illustrated therein are selected to facilitate explanation. The Figures including the apparatus, methods, and compositions of matter illustrated in the Figures are not to be considered limiting unless expressly so stated. For example, the components of various apparatus illustrated in the Figures may be selected for explanatory purposes, and the components may be grouped in the Figures in various ways to facilitate description, so that the apparatus may include various other components or the components may be grouped in various other ways, in other implementations. The steps in the various methods illustrated in the Figures, for example, may be performed in other orders, or the steps in the various methods may be divided or subdivided in various ways, in other implementations. Information flows and process flows in the Figures included herein are indicated by arrows, and are selected for explanatory purposes. It should be understood that other information flows may occur between various components and that other process flows may occur, in various other implementations. The number, position, relationship and dimensions of the elements shown in the Figures to form the various implementations described herein are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the Figures and are utilized to facilitate description thereof. Use herein of relative terms such as generally, about, approximately, essentially, may be indicative of engineering, manufacturing, computational, or scientific tolerances such as ±0.1%, ±1%, ±2.5%, ±5%, or other such tolerances, as would be recognized by those of ordinary skill in the art upon study of this disclosure.

### DETAILED DESCRIPTION OF THE INVENTION

A communication management system is disclosed herein. In various aspects, the communication management system may include a communication device located within a secured facility. The communication device is in networked communication via a communication pathway with an object for the communication of data between the communication device and the object via the communication pathway, in various aspects. The object includes a digital device, and the object is located external of a secured facility, in various aspects. In various aspects, a vendor is included in the communication pathway that acts as intermediary for the communication of data between the communication device and the object. The vendor controls the communication of data between the communication device and the object, and the vendor charges a fee for the communication of the data, in various aspects. An auditor is in communication with the communication pathway to collect at least portions of data communicated between the communication device, the vendor, and the object into an auditor CDR independently of the vendor, in various aspects. The auditor is independent of the vendor, so that, for example, the vendor does not control the auditor, in various aspects. In various aspects, the vendor and the auditor are each operated by independent entities (e.g. corporation, government agency) and the auditor generates the auditor CDR without cooperating with the vendor. For example, the auditor and a superuser may be operated by the secured facility and the vendor as an entity independent of the facility may provide communication of data to the facility. The auditor CDR may be analyzed subsequently by the superuser independent of the vendor, and the superuser may control the auditor, in various aspects.

In certain aspects, the communication management system includes a vendor manager that allows a user of the communication device to select the vendor from among several vendors offered by the vendor manager as choices to the user. The user may be, for example, an inmate at a detention facility as the secured facility. Accordingly, in such aspects, the user has a choice of vendors, and the user may select the vendor based upon pricing or quality of service in a competitive marketplace. The user is not captive to one single vendor, in such aspects. The competitive marketplace may motivate vendors to provide improved quality of service at a lower price. The vendor manager is independent of the several vendors, so that the several vendors do not control the vendor manager, in various aspects. The superuser may control the vendor manager, in various aspects.

Multiple users may communicate data with multiple objects via multiple vendors in various combinations in generally simultaneous communication events, in various aspects. Each communication event of the multiple users may be captured by the auditor for analysis by the superuser.

Communication management systems disclosed herein may include various methods implemented in operable software and may include various apparati that may implement the various method steps of the various methods. Compositions of matter disclosed herein include non-transitory media that includes computer readable instructions that, when executed, cause one or more computers to function as at least portions of the apparatus disclosed herein or to implement method steps of the methods disclosed herein.

Software may be, for example, in the form of high-level code such as C or Java, or may be in the form of machine code. In some aspects, the software may execute on one computer. In other aspects, two or more computers may communicate with one another via network, and the software may be organized in various ways such that portions of the software may be distributed operatively over the two or more computers to be executed by the two or more computers. Although generally described as implemented by software, the methods disclosed herein may be implemented in hardware or in a combination of hardware and software in various aspects. As would be recognized by those of ordinary skill in the art upon study of this disclosure, the methods, apparatus, and compositions of matter disclosed herein may be practiced in distributed computing environments where certain tasks are performed by processors that are linked by network. A nominal representation of data may either be the data itself or a pointer, description, or other data that may be used to create the data.

As used herein, computer includes a computer with one or more processors that may, in various aspects, include memory, display, mouse, keyboard, data storage device(s), I/O device(s), and so forth. Computer may include, for example, single-processor or multiprocessor computers, minicomputers, mainframe computers, as well as personal computers, hand-held computing devices, mobile devices, cellular telephones, smartphones, tablets, and other processor-based devices. Display includes, for example, computer screen, video display, monitor, virtual reality display, mixed reality display, and other visual interfaces.

Network cloud, network, and similar terms, as used herein, includes the Internet, cellular telephone networks (e.g. 4G or 5G), text messaging networks (such as MMS or SMS networks), local area networks (LANs), wide area networks (WANs), and combinations thereof. Data may be communicated over the network cloud by various wired and wireless technologies and combinations thereof. The network cloud may include various data storage devices, input/output devices, servers, routers, amplifiers, wireless transmitters, wireless receivers, optical devices, and so forth, as would be recognized by those of ordinary skill in the art upon study of this disclosure.

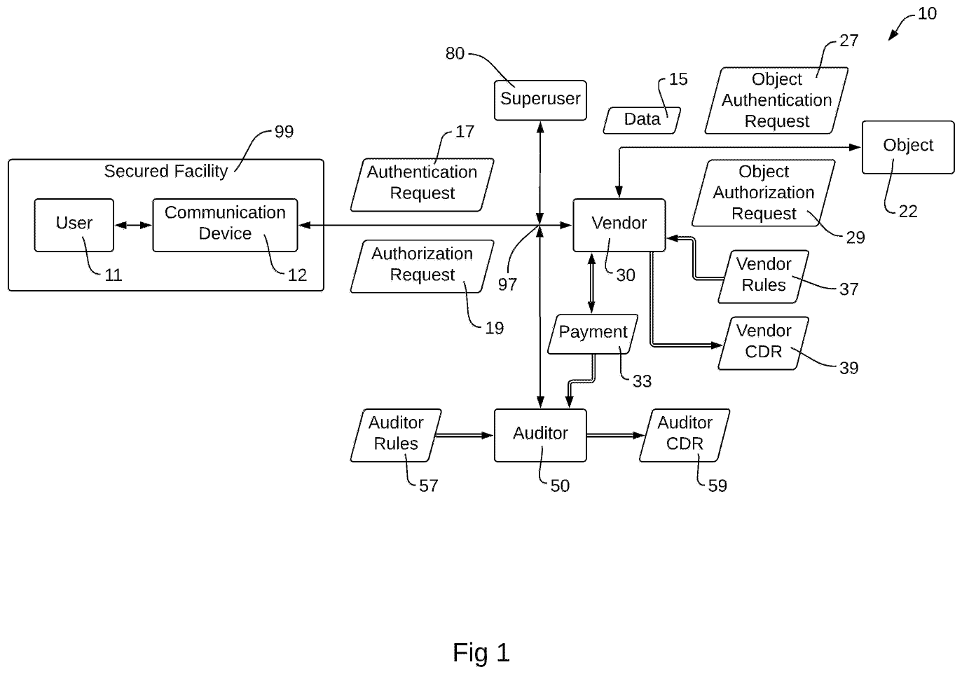

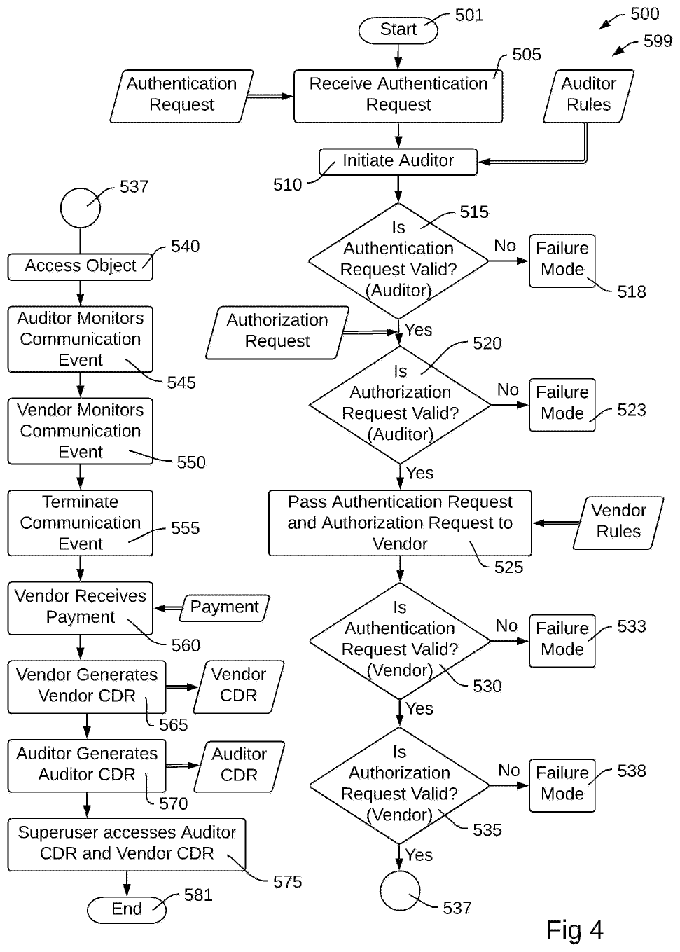

FIG. 1 illustrates exemplary communication management system 10 including user 11, communication device 12, vendor 30, auditor 50, and object 22. As illustrated in FIG. 1, communication device 12 cooperates with user 11 to allow either user 11 or object 22 to implement a communication event, such as communication event 599, 699, 799, 899 (see FIGS. 4, 5, 6, 7, respectively) during which data 15 is communicated via vendor 30 between communication device 12 used by user 11 and object 22 over network 97 while user 11 and communication device 12 are located within secured facility 99. Although auditor 50 and superuser 80 are illustrated as being external of secured facility 99, auditor 50 and/or superuser 80 may or may not be located within secured facility 99, in various implementations.

The communications of user 11 with object 22 may be controlled and may be monitored by communication management system 10, as illustrated in FIG. 1. In this implementation, vendor 30 controls and monitors the communication of data 15 between communication device 12 and object 22 as data 15 is communicated between communication device 12 and object 22 via vendor 30. Auditor 50, in this implementation, is in communication with network 97 to monitor the communication of data 15 between communication device 12 and object 22 as controlled, at least in part, by vendor 30 during the communication event. Auditor 50 may control, at least in part, the communication of data 15 between communication device 12, vendor 30, and object 22, in certain implementations. Auditor 50 acts independently of vendor 30, in various implementations.

In various implementations, communication device 12 may be, for example, a computer generally in the form of a telephone, a kiosk, a tablet, or other digital device, and communication device 12 may be of confinement facility approved correctional grade or meet other standards appropriate to secured facility 99.

Data 15 may include digital data transmitted, at least in part, by VOIP. As used herein, VOIP may include, for example, VoIP/SIP, satellite mobile, or similar protocols, in various implementations. VOIP may include proprietary VOIP, open source VOIP, or combinations of proprietary VOIP and open source VOIP, in various implementations.

Data 15 may include text, audio, video, multimedia, analog PSTN/POTs, or other information that may be in digital format or may be digitizable into digital format. Analog PSTN/POTs communications may be digitized into digital format by communication management system 10, in certain implementations.

Object 22 includes, for example, a computer such as a communication device, telephone, interactive device, smartphone, database, and other digital devices and systems, and combinations thereof accessible to user 11 or that may access user, at least in part, using communication device 12 as controlled by vendor 30. Object 22 may include, for example, banking, inmate trust fund, commissary, money deposit, video visitation, biometric, educational content provider, vocational content provider, religious content provider, therapeutic content provider, credit card processing entity, and third-party prepaid center such as Western Union. Object 22 may represent multiple objects having multiple identities and multiple functionalities, in various implementations.

As illustrated in FIG. 1, vendor 30 acts as an intermediary that communicates, at least in part, data 15 between user 11 using communication device 12 and object 22 over network 97, and vendor 30 receives payment 33 for the communication of data 15. Vendor 30 may control the communication of data 15 so that, for example, user 11 can only communicate data 15 with object 22 using communication device 12 as allowed by vendor rules 37. Vendor rules 37, for example, may authenticate user 11 using authentication request 17 that identifies user 11 to control the access of user 11 to vendor 30. Vendor rules 37 may control objects, such as object 22, that user 11 is allowed to communicate data 15 with in response to authorization request 19. For example, vendor rules 37 may control the time of day during which data 15 may be communicated with object 22, may control the duration of communication of data 15 with object 22, may control the type of data 15 communicated (e.g. text, video, audio, email, web form), may control mono-directional or bi-directional communication of data 15 with object 22, control payment 33 received for the communication of data 15 with object 22, control communication of data 15 based upon availability of payment 33, or control non-recording of data 15 communicated with attorney as object 22.

Similarly, object 22 may only communicate data 15 with communication device 12 as allowed by vendor rules 37. For example, vendor rules 37 may authenticate object 22 using object authentication request 27 generated by object 22 that identifies object 22 to vendor 30 in order to control the access of object 22 to vendor 30. Vendor rules 37 may control whether or not object 22 is allowed to communicate data 15 with communication device 12 used by user 11 in response to object authorization request 29 from object 22. For example, vendor rules 37 may control the identity of user 11 with whom object 22 may communicate data 15, control the time of day during which object 22 may communicate data 15 with user 11 using communication device 12, control the type of data 15 that object 22 may communicate with user 11 using communication device 12, and control payment 33 for the communication of data 15 when the communication event is initiated by object 22.

It should therefore be recognized that authentication request 17 and authorization request 19 may be generated by communication device 12 used by user 11, object authentication request 27 and object authorization request 29 may be generated by the object 22, and vendor 30 and auditor 50 may variously monitor and control communication of data 15 using various combinations of user authentication request 17, object authentication request 27, user authorization request 19, object authorization request 29, in various implementations. Multiple authentication requests, such as authentication request 17, and/or multiple object authentication requests, such as object authentication request 27, may be generated during the communication event. Multiple authorization requests, such as authorization request 17, and/or multiple object authorization requests, such as object authorization request 29, may be generated during the communication event, for example, at initiation of the communication event, during the communication event, and at termination of the communication event. In some implementations, for example, user 11 using communication device 12 initiates the communication event with authentication request 17, authorization request 19, or combinations of authentication request 17 and authorization request 19. In other implementations, for example, object 22 initiates the communication event with object authentication request 27, object authorization request 29, or combinations of object authentication request 27 and object authorization request 29. In various implementations, either communication device 12 used by user 11 or object 22 may terminate the communication event. Data 15 may include authentication request(s), such as authentication request 17, authorization request(s), such as authorization request 19, object authentication request(s), such as object authentication request 27, and object authorization request(s), such as object authorization request 29, generated during the communication event.

Vendor 30 monitors the communication event including data 15 communicated between user 11 and object 22 to generate vendor CDR 39 of the communication event. Vendor CDR 39 may include variously the identity of user 11, identity of communication device 12, identity of object 22, authentication request 17, authorization request 19, object authentication request 27, object authorization request 29, and data 15 communicated between communication device 12 and object 22. Vendor CDR 39 may include payment 33 received by vendor 30 for the communication of data 15, and vendor 30 may interact with object 22, for example, to deduct payment 33.

Auditor 50, in this implementation, monitors the communication between communication device 12 used by user 11, vendor 30, and object 22 independently of vendor 30 to verify vendor rules 37 implemented by vendor 30, verify the control of the communication event by vendor 30, verify payment 33 received by vendor 30 for the communication event, and otherwise monitor communications between communication device 12 used by user 11, vendor 30, and object 22. As illustrated in FIG. 1, an indicia of payment 33 is communicated to auditor 50 to allow auditor 50 to verify payment 33 received by vendor 30.

Similar to vendor rules 37, auditor rules 57, for example, may specify and/or control objects, such as object 22, with which user 11 is allowed to communicate data 15. For example, auditor rules 57 may specify and/or control the time of day during which data 15 may be communicated with object 22, specify and/or control duration of communication of data 15 with object 22, specify and/or control the type of data 15 communicated, control mono-directional or bi-directional communication of data 15 with object 22, specify and/or control payment 33 received for the communication of data 15 with object 22, or specify and/or control non-recording of data 15 communicated with attorney as object 22. While auditor rules 57 and vendor rules 37 should be substantially equivalent at least in part, auditor rules 57 take precedence over vendor rules 37, in various implementations. Vendor rules 37 implement auditor rules 57, in various implementations.

Auditor CDR 59 generated by auditor 50 by monitoring the communication between communication device 12 used by user 11, vendor 30, and object 22 is communicated with superuser 80. Auditor 50 may generate auditor CDR 59 independently of vendor 30 without interaction with vendor 30 by capturing data 15 communicated over network 97 without interaction with vendor 30. Auditor CDR 59 may include variously the identity of user 11, identity of communication device 12, identity of object 22, authentication request 17, authorization request 19, object authentication request 27, object authorization request 29, and data 15 communicated between communication device 12 and object 22. Auditor CDR 59 may include payment 33 received by vendor 30 for the communication of data 15, and auditor 50 may determine payment 33 independent of vendor 30. Auditor CDR 59 may include usage of object 22 as educational content provider, as vocational content provider, or as therapeutic content provider application modules such as educational, vocational, and mental health, etc. The auditor CDR 59 may include information related to recidivism, in certain implementations.

Auditor CDR 59 may be communicated to superuser 80, as illustrated. In some implementations, vendor CDR 39 may be communication to superuser 80, while, in other implementations, vendor CDR 39 is not available to superuser 80. Superuser 80 may be, for example, a computer authorized to access auditor CDR 59 and vendor CDR 39, if accessible, for analysis. Supervisory personnel who oversee communication management system 10 for secured facility 99 may control analysis of vendor CDR 39, when accessible, and auditor CDR 59 at superuser 80. Supervisory personnel who oversee communication management system 10 for secured facility 99 may use superuser 80 to control the generation of auditor CDR 59 by auditor 50, or to alter auditor rules 57.

Although not included in FIG. 1, for purposes of clarity of explanation, communication management system 10 may include computer(s), data storage device(s), display(s), network cloud(s), database(s), operable software, wired and/or wireless communication pathways, and so forth, as would be readily recognized by those of ordinary skill in the art upon study of this disclosure.

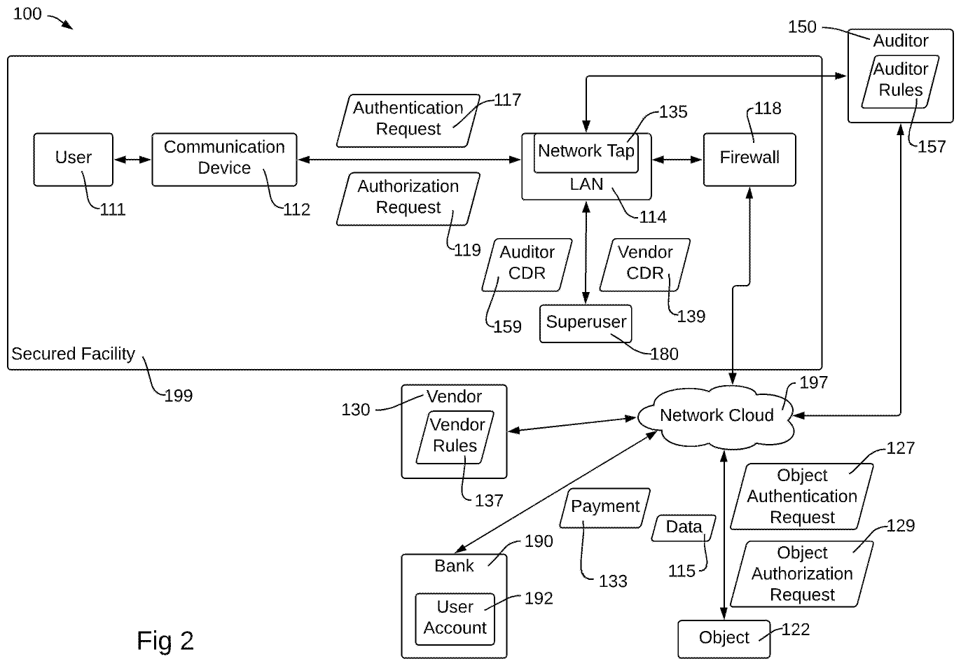

FIG. 2 illustrates exemplary communication management system 100 including user 111, communication device 112, vendor 130, auditor 150, and secured facility 199. User 111 and communication device 112 used by user 111 are located within secured facility 199 as are LAN 114, firewall 118, and superuser 180, in this implementation. Bank 190 that hosts user account 192, vendor 130, auditor 150, and object 122 may be located external to secured facility 199, as illustrated. While user 111 and communication device 112 are illustrated as located within secured facility 199, other portions of communication management system 100 may be physically located either within secured facility 199 or external to secured facility 199 in various ways in various implementations, as would be readily recognized by those of ordinary skill in the art upon study of this disclosure.

Superuser 180 may implement algorithms that analyze auditor CDR 159 and vendor CDR 139, if available, for example, to determine statutory compliance, state and/or federal regulatory compliance, tax compliance, tax documentation, compliance with court orders, compliance with police orders, compliance with security protocols of the secured facility, and/or revenue compliance or documentation. Auditor CDR 159 may be analyzed for compliance with auditor rules 157 where auditor rules 157 may, for example, specify and/or control objects, such as object 122, with which user 111 is allowed to communicate data 115 using communication device 112. For example, auditor rules 157 may specify and/or control the time of day during which data 115 may be communicated with object 122, specify and/or control duration of communication of data 115 with object 122, specify and/or control the type of data 115 communicated, specify and/or control mono-directional or bi-directional communication of data 115 with object 122, specify and/or control payment 133 received for the communication of data 115 with object 122, or specify and/or control non-recording of data 115. Non-compliance of auditor CDR 159 with auditor rules 157 may be documented by superuser 180. Non-compliance of auditor CDR 159 with auditor rules 157 may indicate that vendor 130 is non-compliant with auditor rules 157.

As illustrated in FIG. 2, communication device 112 cooperates with user 111 to allow user 111 to communicate data 115 with object 122 through LAN 114 and firewall 118 using communication device 112 via network cloud 197 and vendor 130 during a communication event, such as communication event 599, 699, 799, 899 (see FIGS. 4, 5, 6, 7, respectively). Data 115 may include text, audio, video, multimedia, or other information. Data 115 may variously include authentication request 117, authorization request 119, object authentication request 127, and object authorization request 129. Data 115 may be communicated, at least in part, by vendor 130 using VOIP.

LAN 114 communicates with communication device 112 and firewall 118, and firewall 118 interfaces LAN 114 with network cloud 197, as illustrated. LAN 114 may be generally disposed within secured facility 199, and LAN 114 may communicate data 115 between communication device 112 and firewall 118 using various wired and wireless technologies and combinations thereof, as would be recognized readily by those of ordinary skill in the art upon study of this disclosure. LAN 114 may include various data storage device(s), input/output device(s), computer(s), router(s), amplifier(s), wireless transmitter(s), wireless receiver(s), optical device(s), and so forth, as would be recognized by those of ordinary skill in the art upon study of this disclosure. Although illustrated as one user 111 communicating with one communication device for purposes of explanation, it should be recognized that any number of users, such as user 111, with any number of corresponding communication devices, such as communication device 112, may communicate data over LAN 114, in various implementations.

Firewall 118 acts as a firewall between LAN 114 and network cloud 197, operating in ways readily recognizable to those of ordinary skill in the art upon study of this disclosure. Data 115 communicated between firewall 118 and network cloud 197 may be encrypted by firewall 118, for example, using SSL security protocol. Communication device 112, LAN 114, firewall 118 and other portions of communication management system 100 may meet standards appropriate to secured facility 199 and may be variously of confinement facility approved correctional grade, in various implementations.

Object 122 is external to LAN 114 and accessible to user 111, at least in part, over LAN 114 through firewall 118 and via network cloud 197, in this implementation.

Bank 190 includes, for example, a bank, commissary, bursar, or other financial entity. User account 192 is hosted by bank 190 to hold funds owned by user 111, and payment 133 may be deducted from user account 192 by vendor 130 to pay vendor 130 for the communication event. Vendor 130, user 111, user 111 and vendor 130, and auditor 150 may communicate with bank 190 including user account 192 via various combinations of network cloud 197, LAN 114, and firewall 118.

Vendor 130 may communicate with communication device 112 including user 111 via network cloud 197, firewall 118, and LAN 114 to control the access of user 111 using communication device 112 to vendor 130, to control the access of object 122 to communication device 112 used by user 111, and to control the communication of data 115 between communication device 112 used by user 111 and object 122. For example, user 111 using communication device 112 can access vendor 130 only as allowed by authentication request 117 that conforms to vendor rules 137, in this implementation. Upon receiving access to vendor 130, vendor 130 then controls the communication between user 111 and object 122 so that user 111 can communicate data 115 with object 122 only as allowed by authorization request 119 that conforms to vendor rules 137, in this implementation.

Similarly, for example, object 122 can access vendor 130 only as allowed by object authentication request 127 that conforms to vendor rules 137. For example, upon receiving access to vendor 130, vendor 130 then controls the communication between user 111 and object 122 so that object 122 can communicated data 115 with communication device 112 used by user 111 only as allowed by object authorization request 129 that conforms to vendor rules 137.

Vendor 130 monitors the communication event including data 115 communicated between user 111 and object 122 to generate vendor CDR 139 of the communication event. Vendor CDR 139 may variously include, for example, the identity of user 111, identity of communication device 112, identity of object 122, authentication request 117, authorization request 119, object authentication request 127, object authorization request 129, and data 115 communicated between communication device 112 and object 122. Vendor CDR 139 may include payment 133 received by vendor 130 from user account 192 hosted by bank 190 for the communication event.

Auditor 150 monitors the communication between user 111, vendor 130, and object 122, as well as payment 133 received by vendor 130 from user account 192 hosted by bank 190 to generate auditor CDR 159, in this implementation. Auditor CDR 159 may include the identity of user 111, identity of communication device 112, identity of object 122, authentication request 117, authorization request 119, and data 115 communicated between communication device 112 and object 122. Auditor CDR 159 may include payment 133 received by vendor 130 for the communication event. Note that communication events initiated by object 122 may be paid for in other ways. User account 192 hosted by bank 190 may include, for example, accounts through which object 122 tenders payment 133, indigent accounts, or other accounts of vendor 130, secured facility 199, or various third parties, as would be readily understood by those of ordinary skill in the art upon study of this disclosure. Payment 133 may be, for example, cash including cash equivalents or credits or debits to account 192, and payment 133 may be tendered from multiple accounts, such as user account 192, as would be readily understood by those of ordinary skill in the art upon study of this disclosure.

As illustrated in FIG. 2, LAN 114 includes network tap 135, and auditor 150 communicates with network tap 135, to monitor the access of user 111 using communication device 112 with vendor 130 and to monitor data 115 communicated with object 122 by user 111 using communication device 112 because data 115 communicated between firewall 118 and network cloud 197 may be encrypted, and, thus, not available to auditor 150. Network tap 135 may be, for example, a hardware device that allows auditor 150 to access data 115 communicated within LAN 114. For example, network tap 135 may be a RIMON probe, packet sniffer, network probe, or other device that allows auditor 150 to generate auditor CDR 159. As illustrated, auditor 150 is in communication with network cloud 197, and auditor 150 may variously communicate with bank 190 including user account 192, vendor 130, and object 122, for example, in order to generate auditor CDR 159. Network tap 135 may be otherwise located about LAN 114, firewall 118, and network cloud 197 to allow auditor 150 to monitor data 115.

As illustrated in FIG. 2, auditor 150 and superuser 180 are in communication via LAN 114 to allow auditor 150 to communicate auditor CDR 159 to superuser 180, in this implementation. In other implementations, for example, auditor 150 and superuser 180 may be in communication at least in part via network cloud 197. In some implementations, vendor CDR 139 may be communicated to superuser 180, while, in other implementations, vendor CDR 139 is not available to superuser 180. Superuser 180 may be, for example, a computer authorized to access auditor CDR 159 and vendor CDR 139, if accessible, for analysis.

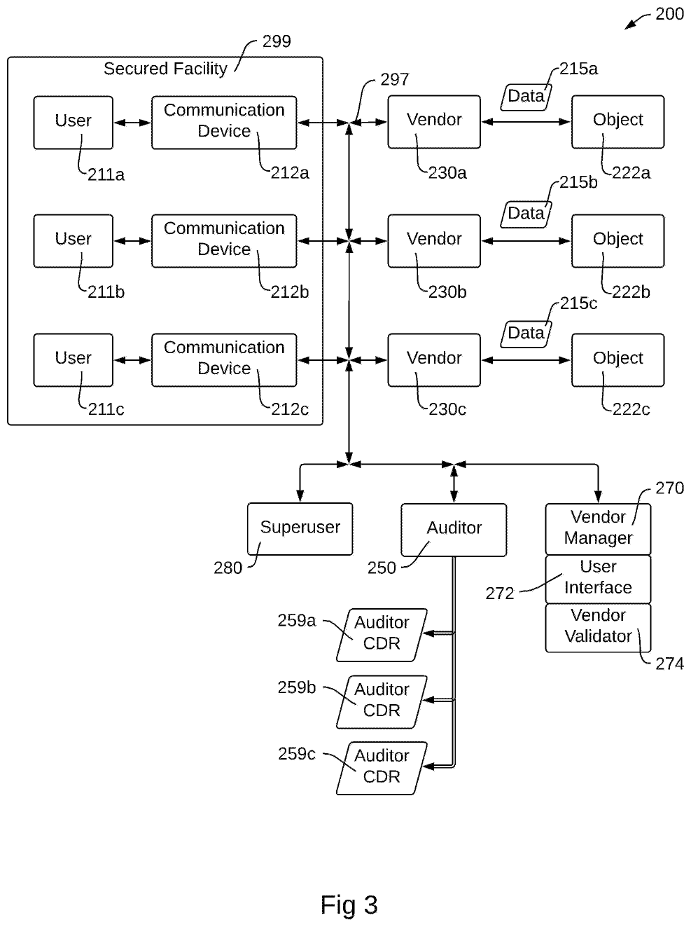

FIG. 3 illustrates exemplary communication management system 200 including users 211a, 211b, 211e in communication with communication devices 212a, 212b, 212c via vendors 230a, 230b, 230c to communicate data 215a, 215b, 215c with objects 222a, 222b, 222c, respectively, over network 297 during communication events, such as communication event 599, 699, 799, 899 (see FIGS. 4, 5, 6, 7, respectively). Users 211a, 211b, 211e and communication devices 212a, 212b, 212c are located within secured facility 299, as illustrated.

Any of communication devices 212a, 212b, 212c may operably communicate with any of vendors 230a, 230b, 230c as selected by respective users 211a, 211b, 211c, in this implementation. For example, communication device 212a operably communicates with any of vendors 230a, 230b, 230c as selected by user 211a, and communication device 212a then communicates with object 222a under control of the selected vendor 230a, vendor 230b, or vendor 230c. Communication management system 200 illustrates that various numbers of and combinations of users, such as users 211a, 211b, 211c, communication devices, such as communication devices 212a, 212b, 212c, vendors, such as vendors 230a, 230b, 230c, may be accommodated in various implementations of the communication management systems disclosed herein, such as communication management system 10, 100, 200.

As illustrated in FIG. 3, vendor manager 270 communicates with communication devices 212a, 212b, 212c and with vendors 230a, 230b, 230c via network 297 to allow users 211a, 211b, 211c to select variously from vendors 230a, 230b, 230c. Auditor 250, in this implementation, communicates with network 297 to monitor communications of users 211a, 211b, 211c using communication devices 212a, 212b, 212c with objects 222a, 222b, 222c, respectively, via any combination of vendors 230a, 230b, 230c. Auditor 250 generates auditor CDR's 259a, 259b, 259c from the communications of users 211a, 211b, 211c using communication devices 212a, 212b, 212c with objects 222a, 222b, 222c, respectively. Auditor CDR's 259a, 259b, 259c may include the identity of vendors 230a, 230b, 230c, respectively. Superuser 280 may access auditor CDR's 259a, 259b, 259c via network 297 for analysis.

As illustrated in FIG. 3, vendor manager 270 includes user interface 272 that allows a user, such as user 211a, 211b, 211c, to select a selected vendor from vendors 230a, 230b, 230c. Vendor validator 274 determines vendors from vendors 230a, 230b, 230c that the user may select. As an example, user 211a may only select vendors 230a, 230b with vendor 230c being not selectable by user 211a. Vendor manager 270 may be generally independent of vendors 230a, 230b, 230c to allow the user, for example, to select from amongst vendors 230a, 230b, 230c without influence from vendors 230a, 230b, 230c. Vendor manager 270 and auditor 250 may be combined in various ways, in various implementations.

As illustrated in FIG. 4, exemplary method 500 implements exemplary communication event 599 using a communication management system, such as communication management system 10, 100, 200. Communication event 599, includes a user, such as user 11, 111, 211a, 211b, 211c, communicating data, such as data 15, 115, 215a, 215b, 215c, between a communication device, such as communication device 12, 112, 212a, 212b, 212c, used by the user and an object, such as object 22, 122, 222a, 222b, 222c. The communication device used by the user communicates the data with the object via a vendor, such as vendor 30, 130, 230a, 230b, 230c, during communication event 599. Communication event 599 includes an authentication request, such as authentication request 17, 117, that, when valid, allows communication between the communication device used by the user and the vendor. Communication event 599 includes an authorization request, such as authorization request 19, 119, that, when valid, allows communication of data between the communication device used by the user and the object. The authentication request authenticates the identity of the user in combination with the communication device, and the authorization request requests communication of data by the user using the communication device with the object, in this implementation. Communication event 599 may include transfer of payment, such as payment 33, 133, to the vendor from a user account, such as user account 192, hosted by a bank, such as bank 190 to compensate the vendor for the communication of the data.

As illustrated in FIG. 4, exemplary method 500 is entered at step 501. At step 505, the authentication request is received from the communication device used by the user as part of communication event 599. The authentication request, which initiates communication event 599, is generated by the user using the communication device, and the authentication request requests access by the user using the communication device to the vendor, in this implementation.

At step 510, an auditor, such as auditor 50, 150, 250 is initiated by the authentication request. At step 515, the auditor checks that the authentication request is valid according to auditor rules, such as auditor rules 57, 157, meaning that access to the vendor by the user in combination with the communication device complies with the auditor rules. If the auditor rules do not allow the user in combination with the communication device to access the vendor, method 500 passes from step 515 to step 518, and method 500 may then enter various failure modes from step 518.

If the auditor rules allow the user in combination with the communication device to access the vendor, method 500 passes from step 515 to step 520. The communication device as directed by the user generates the authorization request that requests communication of data with the object by the user using the communication device. At step 520, the auditor checks that the auditor rules allow the user in combination with the communication device to communicate data with the object as requested by the authorization request. If the auditor rules do not allow the user in combination with the communication device to communicate data with the object, method 500 passes from step 520 to step 523, and method 500 may then enter various failure modes from step 523. If the auditor rules allow the user in combination with the communication device to communicate data with the object, method 500 passes from step 520 to step 525.

At step 525, the authentication request and the authorization request are passed to the vendor. At step 530, the vendor checks that vendor rules, such as vendor rules 37, 137, allow the user in combination with the communication device to access the vendor. If the user in combination with the communication device is not allowed to access the vendor in compliance with the vendor rules, method 500 passes from step 530 to step 533, and method 500 may then enter various failure modes from step 533. If the user in combination with the communication device is authorized to access the vendor in compliance with the vendor rules, method 500 passes from step 530 to step 535.

At step 535, the vendor checks that the vendor rules allow the user in combination with the communication device to communicate data with the object. If the user in combination with the communication device is not authorized to communicate data with the object according to the vendor rules, method 500 passes from step 535 to step 538. Method 500 may then enter various failure modes from step 538. If the user in combination with the communication device is authorized to communicate data with the object according to the vendor rules, method 500 passes from step 535 to step 540 by way of link 537 in the process flow chart of FIG. 4.

At step 540, the user in combination with the communication device accesses the object to communicate data with the object as a portion of communication event 599 in conformance with the authorization request. At step 545, the auditor monitors communication event 599 including monitoring that communication of data between the object and the communication device as used by the user complies with the auditor rules. The auditor may collect at least portions of the data as part of an auditor CDR, such as auditor CDR 59, 159, 259a, 259b, 259c, such as may be allowed by the auditor rules, at step 545.

At step 550, the vendor monitors communication event 599 including monitoring that communication of data between the object and the communication device as used by the user complies with the vendor rules. The vendor may collect at least portions of data as part of a vendor CDR, such as vendor CDR 39, 139, such as may be allowed by the vendor rules, at step 550.

At step 555, communication event 599 is terminated. Communication event 599 may be terminated by the user as controlled by the user, in certain implementations. Communication event 599 may be terminated by the object as controlled by the object, in certain implementations. Communication event 599 may be terminated by the vendor, in certain implementations. For example, the vendor may terminate communication of data when communication of data violates vendor rules including vendor rules that specify the payment, in certain implementations. The auditor may terminate communication event 599 at step 565 if communication event 599 fails to conform to the auditor rules, in certain implementations.

Following termination of communication event 599 at step 555, the vendor receives the payment at step 560 from the user account held by the bank, and the vendor generates the vendor CDR at step 565. The vendor CDR may include authentication request(s) that fail step 530, and the vendor CDR may include authorization request(s) that fail step 535, so that step 565 may be accessed by method 500 following steps 533, 538.

Auditor then generates the auditor CDR at step 570. The auditor may query the user account hosted by the bank to determine the payment to the vendor for communication event 599, and the auditor CDR may include the payment to the vendor for communication event 599. The auditor CDR may include authentication request(s) that fails step 515, and the auditor CDR may include authorization request(s) that fail step 520, so that step 570 may be accessed by method 500 following steps 518, 523.

At step 575, a superuser, such as superuser 80, 180, 280, accesses the vendor CDR, if available, and the auditor CDR. Note that the vendor CDR may not be available to the superuser, in certain implementations. The superuser may analyze the auditor CDR and the superuser may analyze the vendor CDR, if available to superuser 80, for example, for compliance with the auditor rules and/or compliance with the vendor rules. The superuser may, for example, determine agreements or disagreements between the auditor rules and the vendor rules and compliance of the payment received by the vendor with applicable rules and regulations. Exemplary method 500 terminates at step 581.

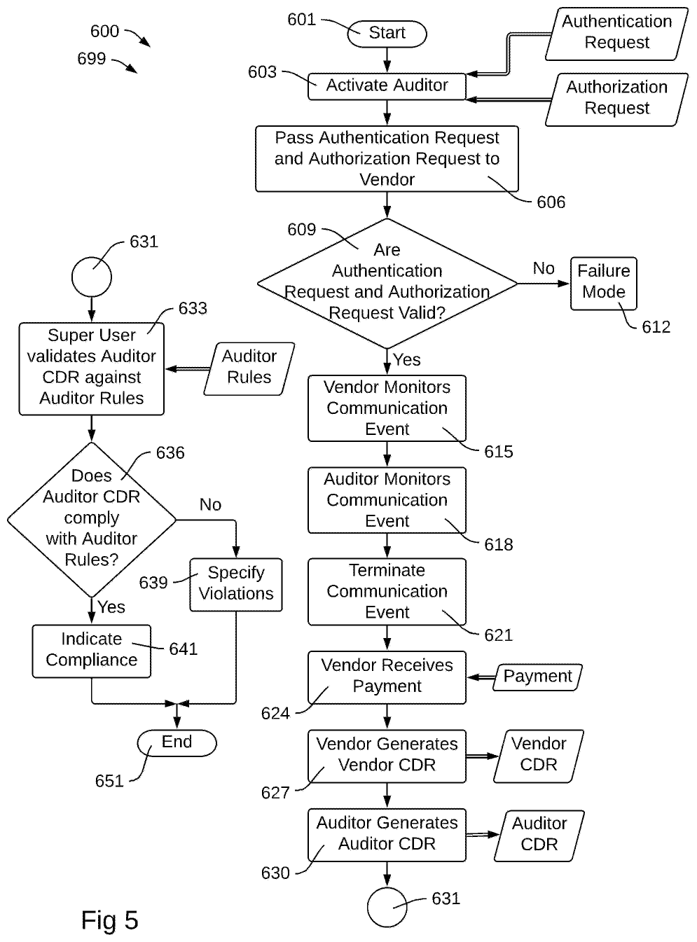

Exemplary method 600 implementing exemplary communication event 699 using a communication management system, such as communication management system 10, 100, 200, is illustrated in FIG. 5. As illustrated in FIG. 5, exemplary method 600 is entered at step 601. At step 603, receipt of an authentication request, such as authentication request 17, 117, and an authorization request, such as authorization request 19, 119, activates an auditor, such as auditor 60, 160, 260. The authentication request and the authorization request are generated by a user, such as user 11, 111, 211a, 211b, 211c, in combination with a communication device, such as communication device 12, 112, 212a, 212b, 212c. At step 606, the auditor passes the authentication request and the authorization request to a vendor, such as vendor 30, 130, 230a, 230b, 230c. In method 600, note that auditor does not check that the authentication request and authorization request are valid but only passes the authentication request and authorization request to the vendor. The authentication request and authorization request may be either simultaneous or sequential.

At step 609, the vendor checks the validity of the authentication request and the authorization request against vendor rules, such as vendor rules 37, 137. If the user in combination with the communication device is not allowed to access the vendor in compliance with the vendor rules, or if the user in combination with the communication device is not authorized to communicate data, such as data 15, 115, 215a, 215b, 215c, with an object, such as object 22, 122, 222a, 222b, 222c, according to the vendor rules, method 600 passes from step 609 to step 612, and method 600 may then enter various failure modes from step 612.

If the user in combination with the communication device is allowed to access the vendor in compliance with the vendor rules and the vendor rules allow the user in combination with the communication device to communicate data with the object, method 600 passes from step 609 to step 615.

The vendor then monitors the communication event 699 including data communicated between the object and the communication device used by the user, at step 615. At step 618, the auditor monitors the communication event 699 including data communicated between the object and the communication device used by the user. Note that the auditor may communicate with a network tap, such as network tap 135, included in a LAN, such as LAN 114 or otherwise included in a network, such as network 97, 197, 297, to monitor the communication event 699 including data communicated between the object and the communication device used by the user.

The communication event is terminated at step 621. Payment, such as payment 33, 133, for the communication event is received by the vendor at step 624. The vendor generates a vendor CDR, such as vendor CDR 39, 139, at step 627, and the auditor generates an auditor CDR, such as auditor CDR 59, 159, 259a, 259b, 259c, at step 630. The auditor CDR may include the payment received by the vendor at step 624.

Method 600 proceeds from step 630 to step 633 by way of link 631 in the process flow chart of FIG. 5. At step 633, a superuser, such as superuser 80, 180, 280 accesses the auditor CDR to validate the auditor CDR against auditor rules, such as auditor rules 57, 157. At step 636, compliance of the auditor CDR with the auditor rules is tested. If the auditor CDR does not comply with the auditor rules, method 600 passes from step 636 to step 639. The violations of auditor rules by auditor CDR are then specified at step 639. Violation of auditor rules by auditor CDR may indicate, inter alia, that the vendor using the vendor rules is not in compliance with the auditor rules.

If the auditor CDR complies with the auditor rules, method 600 passes from step 636 to step 641. Method 600 indicates compliance at step 641. Compliance of auditor CDR with auditor rules may indicate that vendor using the vendor rules complies with the auditor rules.

Method 600 passes to step 651 from either step 639 or step 641, and method 600 terminates at step 651.

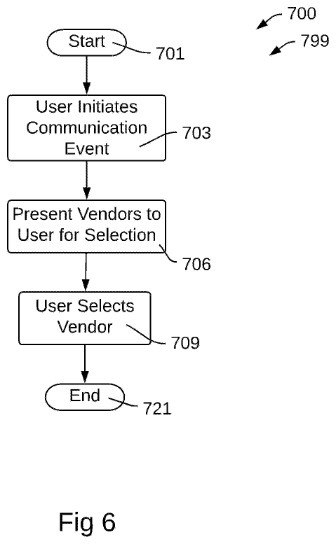

FIG. 6 illustrates exemplary method 700 implementing exemplary communication event 799 using a communication management system, such as communication management system 200. As illustrated in FIG. 6, exemplary method 700 is entered at step 701, and at step 703 a user, such as user 11, 111, 211a, 211b, 211c, initiates communication event 799. Vendor manager, such as vendor manager 270, presents vendors to the user for selection by the user using a user interface, such as user interface 272, at step 706. A vendor validator, such as vendor validator 274, may determine which vendors are presented to the user for selection by the vendor manager using the user interface.

At step 709 the user then selects the vendor using the user interface. Method 700 may, for example, then enter method 500 or method 600 from step 709, and exemplary communication event 799 may then proceed generally according to method 500 or method 600. Method 700 terminates at step 721.

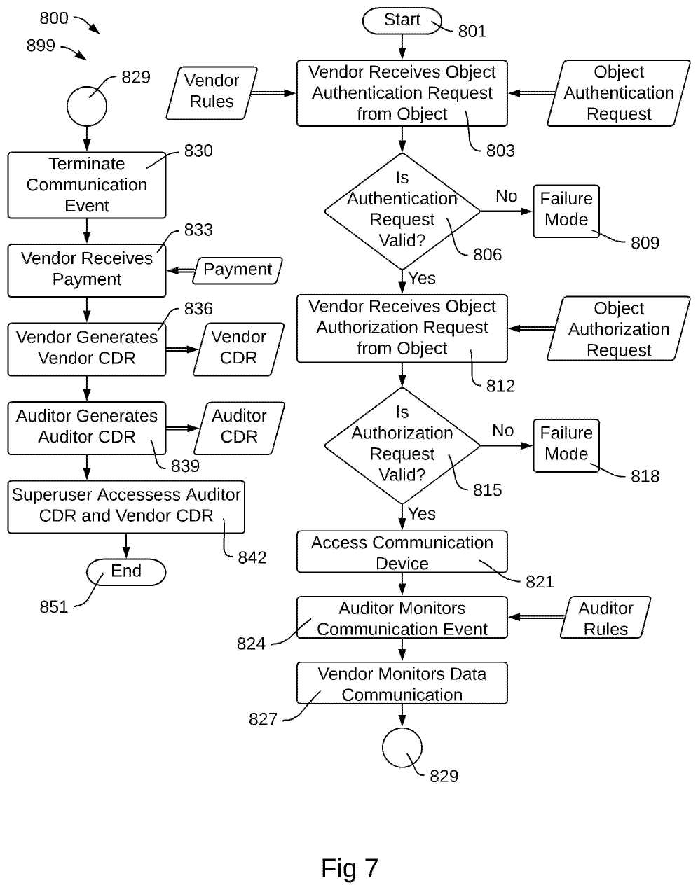

Exemplary method 800 implementing exemplary communication event 899 using a communication management system, such as communication management system 10, 100, 200, is illustrated in FIG. 7. As illustrated in FIG. 7, exemplary method 800 is entered at step 801. At step 803, a vendor, such as such as vendor 30, 130, 230a, 230b, 230c, receives an object authentication request, such as object authentication request 27, 127 communicated from an object, such as object 22, 122, 222a, 222b, 222c, via a network, such as network 97, 197, 297. At step 806, the vendor checks the validity of the authentication request against vendor rules, such as vendor rules 37, 137. If the object is not allowed to access the vendor in compliance with the vendor rules, method 800 proceeds from step 806 to step 809, and method 800 may then enter various failure modes from step 809. If the object is allowed to access the vendor in compliance with the vendor rules, method 800 proceeds from step 806 to step 812.

At step 812, the vendor receives an object authorization request, such as object authorization request 29, 129, to communicate data, such as data 15, 115, 215a, 215b, 215c, with a communication device, such as communication device 12, 112, 212a, 212b, 212c, used by a user, such as user 11, 111, 211a, 211b, 211c.

At step 815, the vendor checks that the object authorization request is valid according to the vendor rules. If the object authorization request is not valid, method 800 proceeds from step 815 to step 818, and a failure mode is entered at step 818. If the object authorization request is valid, method 800 proceeds from step 815 to step 821, and the object accesses the communication device at step 821. At step 824, an auditor, such as auditor 60, 160, 260, monitors communication of data between the object and the communication device. The vendor monitors communication of data between the object and the communication device, at step 827. Method 800 proceeds from step 827 to step 830 by way of link 829 in the process flow chart of FIG. 7.

The communication event is terminated at step 830, and the vendor receives payment, such as payment 33, 133, at step 833. The vendor generates a vendor CDR, such as vendor CDR 39, 139, at step 836, and the auditor generates an auditor CDR, such as auditor CDR 59, 159, 259a, 259b, 259c, at step 839. The auditor CDR may include the payment received by the vendor at step 833.

At step 842, a superuser, such as superuser 80, 180, 280, accesses the auditor CDR to validate the auditor CDR against auditor rules, such as auditor rules 57, 157. The superuser may validate the vendor CDR, if available, against auditor rules, at step 842. Method 800 including communication event 899 terminates at step 851.

The foregoing discussion along with the Figures discloses and describes various exemplary implementations. These implementations are not meant to limit the scope of coverage, but, instead, to assist in understanding the context of the language used in this specification and in the claims. The Abstract is presented to meet requirements of 37 C.F.R. § 1.72(b) only, and the Abstract is not intended to identify key elements of the apparatus, methods, and compositions of matter disclosed herein or to delineate the scope thereof. Upon study of this disclosure and the exemplary implementations herein, one of ordinary skill in the art may readily recognize that various changes, modifications and variations can be made thereto without departing from the spirit and scope of the inventions as described herein and as defined in the following claims.

The invention claimed is:

1. A method for managing data communication from a secured facility, comprising the steps of:
communicating data between a communication device located within said secured facility and an object located external of said secured facility via a communication pathway;
controlling the communicating of the data between the communication device and the object by a vendor included in the communication pathway; and
collecting at least portions of data communicated between the communication device, the vendor, and the object by an auditor into an auditor CDR independent of the vendor, the auditor being in communication with the communication pathway.

2. The method of claim 1, further comprising the step of:
determining that the auditor CDR complies with auditor rules.

3. The method of claim 1, further comprising the step of:
determining that the communication of data between the communication device and the object complies with the auditor rules.

4. The method of claim 3, wherein the auditor rules are specific to a user of the communication device.

5. The method of claim 3, wherein the auditor rules are specific to the object.

6. The method of claim 1, wherein a payment received by the vendor is specified in the auditor CDR.

7. The method of claim 1, further comprising the step of:
initiating the communication of data between the communication device and the object by a user using the communication device.

8. The method of claim 1, further comprising the step of:
initiating the communication of data between the communication device and the object by the object.

9. The method of claim 1, wherein data is communicated at least in part by voice over Internet protocol (VOIP) implemented at least in part by the vendor.

10. The method of claim 1, wherein the vendor controls the communication of data between the communication device and the object in compliance with vendor rules.

11. The method of claim 1, further comprising the step of:
using the communication device for selecting the vendor from several vendors presented to the communication device.

12. The method of claim 1, wherein the communication device is used by a user, the user being an inmate held in said secured facility comprised as a detention facility.

13. A communication management system, comprising:
an object comprising a digital device, the object located external of a secured facility;
a communication device in networked communication via a communication pathway with the object to communicate data between the communication device and the object over the communication pathway, the communication device located within the secured facility;
a vendor included in the communication pathway to act as intermediary for communication of data between the communication device and the object, the vendor controls the communication of data between the communication device and the object; and
an auditor in communication with the communication pathway to collect at least portions of data communicated between the communication device, the vendor, and the object into an auditor CDR, the auditor independent of the vendor.

14. The communication management system of claim 13, further comprising:
a superuser in communication with the auditor to access the auditor CDR in order to determine that the auditor CDR complies with auditor rules.

15. The communication management system of claim 13, wherein a payment received by the vendor is specified in the auditor CDR.

16. The communication management system of claim 13, wherein data is communicated at least in part by voice over Internet protocol (VOIP) implemented at least in part by the vendor.

17. The communication management system of claim 13, wherein the vendor controls the communication of data between the communication device and the object in compliance with vendor rules.

18. The communication management system of claim 17, further comprising:
a superuser in communication with the auditor to access the auditor CDR in order to determine that the vendor rules comply with auditor rules.

19. The communication management system of claim 13, further comprising:
a vendor manager that presents several vendors to the communication device, the vendor is selected from the several vendors using the communication device in cooperation with the vendor manager.

20. A non-transitory computer readable media storing a computer program comprising instructions that, when executed, cause a computer to perform the steps of:
communicating data between a communication device located within a secured facility and an object located external of said secured facility over a communication pathway;
controlling the communicating of the data between the communication device and the object by a vendor included in the communication pathway; and
collecting at least portions of data communicated between the communication device, the vendor, and the object by an auditor independent of the vendor into an auditor CDR, the auditor being in communication with the communication pathway.
